(19) United States
(12) Patent Application Publication
(10) Pub. No.: US 2022/0244959 A1
(43) Pub. Date: Aug. 4, 2022

(54) SYSTEM AND METHOD FOR PARALLEL COMBINATORIAL DESIGN

(71) Applicant: GSI Technology Inc., Sunnyvale, CA (US)

(72) Inventor: Dan ILAN, Herzliya (IL)

(21) Appl. No.: 17/590,837

(22) Filed: Feb. 2, 2022

Related U.S. Application Data
(60) Provisional application No. 63/144,486, filed on Feb. 2, 2021.

(51) Int. Cl. G06F 9/30; G06F 17/16

(52) U.S. Cl. CPC G06F 9/30036; G06F 17/16; G06F 9/3004; G06F 9/3009

(57) ABSTRACT

A system for parallel combinatorial design includes a processor, an in-memory vector processor and a storage unit. The processor includes a seed generator, a Cspan generator and a rule checker. The seed generator generates at least one seed to generate combinations of length N, defining a space of N choices of which M choices are to be selected. The Cspan generator generates at least one combination from the at least one seed and stores each combination in a separate column of the in-memory vector processor. The rule checker performs a parallel search at least in the in-memory vector processor for combinations which satisfy a rule and the storage unit receives search results of the rule checker from the in-memory vector processor.

### CROSS REFERENCE TO RELATED APPLICATIONS

This application claims priority from U.S. provisional patent application 63/144,486, filed Feb. 2, 2021, which is incorporated herein by reference.

### FIELD OF THE INVENTION

The present invention relates to combinatorial design theory generally and to its implementation in particular.

### BACKGROUND OF THE INVENTION

Combinatorial design theory considers the types of combinations X elements can make with each other. Consider a card game with 52 cards. Combinatorics determines how many different combinations of cards there are if each of A players can only have B cards at a time. For example, if the game rule is that a player may draw 7 cards from a deck of 52 cards, then there are Cmn(7, 52) possible combinations, where:

Cmn(m,n)=n!/(m!*(n−m)!) (Equation 1)

This is important to know, particularly when trying to implement a game by having a computer generate the cards for each user according to the rules of the game.

Combinatorial design theory has matured, with applications in cryptography, communications, and storage system design to mention just a few areas. Even a finite geometry problem can be described as a problem in combinatorial design. For example, a projective plane of order 7 is formally defined as a set of 57 points and 57 lines, with the following properties:
a. Every two points are connected by exactly one line;
b. Every two lines intersect at exactly one point;
c. Every point has 8 lines crossing it; and
d. Every line contains 8 points.

The four properties define the allowable combinations. Different situations can be modeled using this kind of projective plane. For example, DOBBLE™ is a card game based on a projective plane of order 7. The game has 55 cards, each with 8 symbols on it. The symbols are chosen from 55 possible symbols. The players select 2 cards by chance and have to find the one and only symbol they have in common.

To create the game using a computer, the computer needs to be able to generate all possible cards and from them, select 55 cards to present to the user. The rule is that each card has 8 symbols on each of which any pair of the 55 cards have only 1 symbol in common. Unfortunately, generating all possible combinations, when the number of combinations is in the billions, takes a very significant amount of computing power. Moreover, checking to find which of the possible combinations satisfies a given rule also takes a lot of computing power.

### SUMMARY OF THE PRESENT INVENTION

There is therefore provided, in accordance with a preferred embodiment of the present invention, a system for parallel combinatorial design. The system includes a processor, an in-memory vector processor and a storage unit. The processor includes a seed generator, a Cspan generator, and a rule checker. The seed generator generates at least one seed to generate combinations of length N, defining a space of N choices of which M choices are to be selected. The Cspan generator generates at least one combination from the at least one seed and stores each combination in a separate column of the in-memory vector processor. The rule checker performs a parallel search at least in the in-memory vector processor for combinations which satisfy a rule. The storage unit receives search results of the rule checker from the in-memory vector processor.

Moreover, in accordance with a preferred embodiment of the present invention, the storage unit is implemented in the processor or in the in-memory vector processor.

Further, in accordance with a preferred embodiment of the present invention, the seed generator generates a next seed if all possible seeds for N and M have not been generated, and the Cspan generator generates a plurality of combinations from the next seed and stores the combinations separately in columns of the in-memory vector processor.

Still further, in accordance with a preferred embodiment of the present invention, the seed generator is a recursive, parallel seed generator which recursively generates a multiplicity of threads, each thread generating a plurality of seeds.

Moreover, the Cspan generator generates at least an initial combination from each at least one seed, stores each the initial combination in the separate column, and generates a next combination from a current combination for each combination currently stored in the separate column.

Further, in accordance with a preferred embodiment of the present invention, the storage unit provides the search results to the rule checker to check which next combination satisfies the rule with respect to previous the search results.

There is also provided, in accordance with a preferred embodiment of the present invention, a system for parallel combinatorial design which includes an in-memory vector processor including a memory array and a controller. The memory array has a seed portion and a combination portion. The controller includes an in-memory seed generator, an in-memory Cspan generator and an in-memory rule checker. The in-memory seed generator generates a plurality of further seeds from start-up seeds, each start-up seed being held in a separate column of the seed portion. The in-memory seed generator also operates on a plurality of the separate columns in parallel to generate the further seeds. The in-memory Cspan generator generates at least an initial combination from each the start-up seed and from each the further seed and stores each the initial combination in a separate column of the combination portion. The in-memory rule checker searches in the combination portion for combinations which satisfy a rule. A storage area of the combination portion receives search results of the in-memory rule checker. The in-memory Cspan generator generates a next combination from a current combination for each combination currently stored in the separate column of the combination portion and the in-memory rule checker checks which the next combination satisfies the rule with respect to the search results stored in the storage area.

There is also provided, in accordance with a preferred embodiment of the present invention, a method for generating seeds defining a set of combinations of length N having M set-bits from a set of seed elements. The method includes iterating over groups of seed elements to generate potential seeds, and selecting as candidate seeds those whose set of seed elements sum to a value between N-M and N.

Moreover, in accordance with a preferred embodiment of the present invention, the iterating includes incrementing a value of one seed element of the set of seed elements.

Further, in accordance with a preferred embodiment of the present invention, the iterating and the selecting are performed recursively.

Still further, in accordance with a preferred embodiment of the present invention, the method also includes generating multiple seed generating threads, where each the thread has a different sum of the seed elements.

Moreover, in accordance with a preferred embodiment of the present invention, the method also includes having a startup seed per each the thread, and each the thread incrementing the value of a largest seed element of its startup seed sequentially.

There is also provided, in accordance with a preferred embodiment of the present invention, a method for parallel combinatorial design. The method includes generating at least one seed to generate combinations of length N, defining a space of N choices of which M choices are to be selected, generating at least one combination from the at least one seed, storing each combination in a separate column of an in-memory vector processor, performing a parallel search at least in the in-memory vector processor for combinations which satisfy a rule, and receiving results of the parallel search from the in-memory vector processor.

Further, in accordance with a preferred embodiment of the present invention, receiving results includes storing the results in the in-memory vector processor.

Still further, in accordance with a preferred embodiment of the present invention, the first generating includes generating a next seed if all possible seeds for N and M have not been generated, and the second generating includes generating a plurality of combinations from the next seed.

Moreover, in accordance with a preferred embodiment of the present invention, the first generating includes recursively generating a multiplicity of threads, each thread generating a plurality of seeds.

Further, in accordance with a preferred embodiment of the present invention, the second generating includes generating at least an initial combination from each the at least one seed, storing each the initial combination in the separate column, and generating a next combination from a current combination for each combination currently stored in the separate column.

Still further, in accordance with a preferred embodiment of the present invention, the method also includes checking which the next combination satisfies the rule with respect to previous the results.

Finally, there is also provided, in accordance with a preferred embodiment of the present invention, a method for parallel combinatorial design. The method includes in-memory generating a plurality of further seeds from start-up seeds, each start-up seed being held in a separate column of a seed portion of a memory array, the generating operating in parallel on a plurality of the separate columns of the seed portion to generate the further seeds, in-memory generating at least an initial combination from each the start-up seed and from each the further seed, storing each initial combination in a separate column of a combination portion of the memory array, in-memory searching in the combination portion for combinations which satisfy a rule, receiving results of the searching in the combination portion, in-memory generating a next combination from a current combination for each combination currently stored in the separate column of the combination portion, and in-memory checking which the next combination satisfies the rule with respect to the results.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a tabular illustration of a combination span for Cspan([2,4]);

FIG. 2 is a schematic illustration of a system for parallel combinatorial design, constructed and operative in accordance with a preferred embodiment of the present invention;

FIG. 3 is a schematic illustration of elements of an in-memory vector processor, useful in the system of FIG. 2;

FIGS. 4A and 4B are schematic illustrations of an alternative system, in which each column of an array generates a different Cspan, constructed and operative in accordance with an alternative embodiment of the present invention, where FIG. 4A shows a separate storage unit and FIG. 4B shows an in-memory storage unit;

FIG. 5 is a tabular illustration of a matrix of possible seed elements and their sums for M=3 and N=7, useful in understanding the system of FIGS. 4A and 4B;

FIG. 6 is an algorithmic illustration of a method to recursively produce seeds, useful in the system of FIGS. 4A and 4B;

FIG. 7 is a tabular illustration of two seeds of a 10-bit sequence;

FIGS. 8A and 8B are tabular illustrations of seed permutations for a 10-bit sequence, where FIG. 8A is the initial permutation or the “startup” seed while the corresponding table element in FIG. 8B is the final seed permutation;

FIG. 9A is a flow chart illustration of a process for a single in-memory thread; and

FIG. 9B is a schematic illustration of a system implementing the method of FIG. 9A.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that parallel determination of combinations increases the speed at which they can be generated. Applicant has also realized that operating in an in-memory vector processor is significantly more efficient, since the combinations may be generated in memory, which eliminates the energy and time that the prior art wastes when moving data from an external memory to the registers and ALU (arithmetic logic unit) of a CPU (central processing unit). Applicant has also realized that the rule may be checked in-memory once the combinations have been generated, providing further time and energy savings.

Applicant has realized that using seeds to generate the combinations in memory is even more efficient and that one way to define the seeds is to use sparse sequence encoding to define them. Sparse sequence encoding lists only where the 1's of a sequence are. Thus, a vector or sequence having the bit value of 111000001 may be encoded as (0,1,2,8), where the first bit location is defined as the 0^{th} bit location.

Without loss of generality, the first element of the initial sequence generated by the seed may be defined to always be ‘1’ and thus, a seed S may be defined even more compactly by listing not where the 1's are but by the number of elements of the sequence between consecutive 1's. Thus, the sparse encoded sequence of (0,1,2,8), which can generate the full initial sequence of 111000001, may be represented by the seed S of [1,1,6] (i.e., start the sequence with a 1, the next 1 bit in the sequence is one location away, the following 1 bit is one location away and the last 1 bit is six locations away. Thus, the sequence is 111000001).

Moreover, each seed S may be defined as an initial sequence from which other sequences, known as “permutations of the seed”, may be generated. Each permutation may be generated by a shift and rotate operation on the sequence. Thus, a seed of 1010001 becomes 1101000 by shifting all digits of the seed sequence 1010001 to the right (creating_101000) and bringing the last digit, a ‘1’, to the beginning of the new sequence (creating 1101000).

In this way, seed S may generate multiple permutations and the set of permutations of seed S may be called the “span of the seed” or its “Cspan”. Each permutation in the set defines one combination of length N, where N is the number of possible choices (e.g., 55 in the case of the game DOBBLE). We can also define M as the number of items to select out of N (e.g., 8 in the case of the game DOBBLE).

Therefore, seed S may be compactly represented as an (M−1)-tuple of elements Sᵢ used to generate an initial combination in the Cspan. As mentioned hereinabove, all the initial sequences have their first bit as 1. Therefore, the compact seed representation has M−1 elements. The elements Sᵢ may define the locations of the 1's in a bit vector, or sequence or combination, of length N.

For example, if M is 3 and N is 7, then 3 locations in each 7-bit vector are 1. Exemplary seeds are: [1,4] and [2,4]. The [1,4] seed indicates that there are 1 bits at locations {0,1,5}. Thus, a first combination CS[0] from the [1,4] seed may be expressed as a bit-vector “1100010”. The [2,4] seed indicates that there are 1 bits at locations {0,2,6}. Thus, a first combination CS[0] from the [2,4] seed may be expressed as a bit-vector “1010001”.

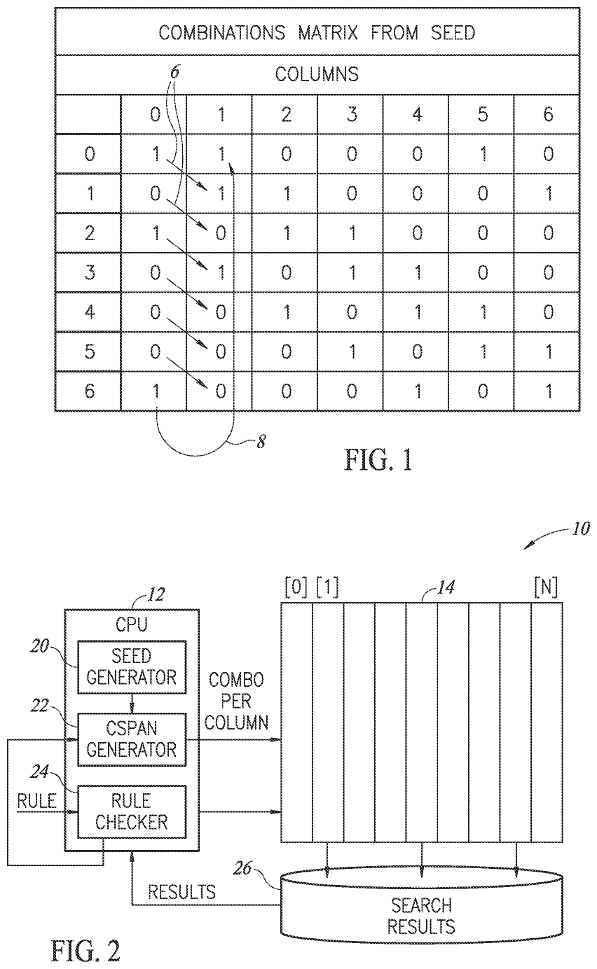

Reference is now briefly made to FIG. 1, which is a table for Cspan([2,4]). The rows of the table are the bits in each combination and the columns are the different combinations. The first column of table is combination CS[0], whose 1 locations are {0,2,6} and thus, the bit vector is “1010001”. As Applicant has realized, to generate the other combinations from the same seed, each column may be generated from the previous column by a shift down (indicated by arrows 6) and a rotate from the end to the beginning of the column (indicated by long arrow 8). Thus, combination CS[0]=1010001 in the first column becomes combination CS[1]=1101000 in the second column, etc. The 7 possible combinations from seed [2,4] are shown in the 7 columns of FIG. 1.

Reference is now made to FIG. 2, which illustrates a system 10 for parallel combinatorial design, which may generate combinations and then check them against a rule. System 10 comprises a central processing unit (CPU) 12, an in-memory vector processor 14, such as the Gemini associative processing unit (APU), commercially available from GSI Technology Inc., of the USA, and a storage unit 26 to store the search results.

CPU 12 comprises a seed generator 20 to generate a seed, given the number N of choices and the number M of items to select out of N, a Cspan generator 22 to generate the Cspan of the seed and to store each individual combination of the Cspan as a vector in one column of in-memory vector processor 14, and a rule checker 24 to activate in-memory vector processor 14 to search the current set of combinations according to a received rule. In-memory vector processor 14 may provide the combinations which match the rule to storage unit 26, which may be implemented as part of CPU 12 or of in-memory vector processor 14, as discussed hereinbelow.

Seed generator 20 may generate seeds according to any suitable algorithm.

The rule may be any appropriate rule which qualify the cards or of any other purpose requiring combinatorial design. For example, the rule might be “find a combination which has exactly one common set-bit location with every previously found combination (as stored in storage unit 26)”. Rule checker 24 may generate a search request for a specific combination to in-memory vector processor 14 to search all columns to find those columns which have one and only one set bit in common with the currently requested combination. Such a search may be very fast, since, as described hereinbelow, processor 14 may operate on all columns in parallel, with the search results being output directly to storage unit 26. Rule checker 24 may then review the search results to determine which, if any, of the combinations output to storage unit 26 will be accepted as a solution.

Rule checker 24 may repeat the search multiple times, each time with a different combination to match.

Once rule checker 24 may finish its review for the current seed, it may activate seed generator 20 to generate a new seed and may repeat the process on the Cspan for that seed.

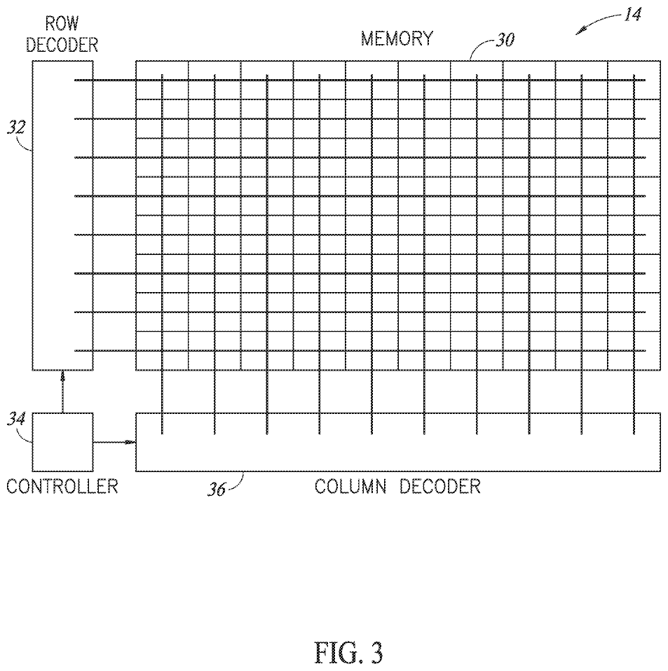

Reference is briefly made to FIG. 3, which generally illustrates elements of in-memory vector processor 14. Processor 14 comprises an associative memory array 30, a row decoder 32, a column decoder 36 and a controller 34. Array 30 comprises a multiplicity of sections, each having a plurality of cells arranged in rows (defined by word lines) and columns (defined by bit lines), where a vector to be operated upon may be stored in a column and a plurality of vectors may be stored at one time.

Row decoder 32 may activate multiple word lines concurrently, which may cause the cells in those rows to be activated and to provide their data to their associated bit lines. Each bit line may connect a column of cells and, when multiple word lines are activated, each bit line may receive a Boolean function of the activated cells in its column. Column decoder 36 may receive the results of the Boolean function, per column. Each bit line may effect a bit line processor, providing its results to column decoder 36 and operating on the cells in its column.

Each section may provide a bit line processor for a single bit of a vector. A column of bit line processors may operate on a single vector and a row of bit line processors may operate on the same bit of multiple vectors. Activating multiple rows of one section may result in concurrent computation on the same bit of multiple vectors. Activating multiple rows of the multiple sections storing vectors may result in concurrent computation on the multiple vectors. Controller 34 may control the activation of the rows and the columns to perform a particular computation.

Storage unit 26 may be any suitable storage unit. In one embodiment, it may be associated with CPU 12, in which case, storage unit 16 may provide the search results to rule checker 24 whenever rule checker 24 needs to check the current results against the previously found results.

In another embodiment, storage unit 26 may be formed of a section of in-memory vector processor 14 not being used to store the combinations. In this embodiment, rule checker 24 may perform a second search in processor 14, this time in the section acting as storage unit 26, to check the rule against the currently found combinations with respect to the previously found combinations and to determine which ones will be accepted as a solution or an interim solution. It will be appreciated that this embodiment may be useful for situations where the number N of possible choices may be relatively small (for example, in DOBBLE, N is only 55), given that in-memory vector processor 14 is also being used for searching the combinations, of which there typically are billions or more.

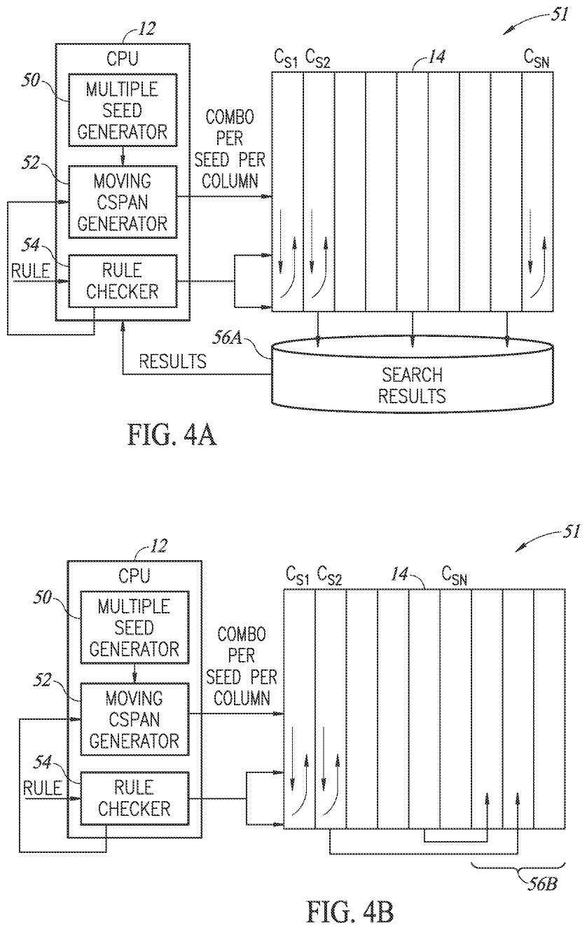

Reference is now made to FIGS. 4A and 4B, which illustrate an alternative system 51 of the present invention, in which each column of processor 14 may generate a different Cspan. As in the previous embodiment, system 51 also comprises CPU 12, in-memory vector processor 14 and a storage unit, where FIG. 4A shows a separate storage unit 56A and FIG. 4B shows an in-memory storage unit 56B implemented as a section of in-memory vector processor 14. In addition, in this embodiment, CPU 12 comprises a multiple seed generator 50, a moving Cspan generator 52, and a rule checker 54. Multiple seed generator 50 may generate all possible seeds given the number N of choices and the number M of items to select out of N. Moving Cspan generator 52 may generate a first combination CS[0] for each seed and may store each per-seed, first combination in in-memory vector processor 14, one per column.

As in the previous embodiment, rule checker 54 may search vector processor 14 to find combinations which satisfy the received rule. Rule checker 54 may implement any suitable algorithm, such as evaluating a logical/arithmetic function with the combination as an argument, and checking if the result value matches the expected value or the design rules.

For DOBBLE, rule checker 54 may utilize in-memory storage unit 56B to hold the previously found combinations. This may make checking for the current combinations easier, since DOBBLE requires selecting combinations which have exactly 1 element in common with every other already found combination (i.e., with every other result). In order to do so, rule checker 54 may activate vector processor 14 to test each combination candidate with each of the found combinations and admit only those that qualify the rule for all.

In accordance with a preferred embodiment of the present invention, once all first combinations have been checked, moving Cspan generator 52 may activate in-memory processor 14 to perform a parallel shift and rotate, in all columns at the same time, to generate next combination CS[1] per column. Rule checker 54 may then repeat the search, checking the newly found combinations according to the rule.

System 51 may repeat the process until all combinations generated or until the design goal is achieved. Moreover, if the total number of seeds exceeds the number of columns in processor 14, system 51 may repeat the entire process with a next set of seeds.

Applicant has realized that seed generators 20 and 50 may be improved by taking advantage of symmetries that may reduce the number of seeds that need to be generated, which may reduce the time to generate them.

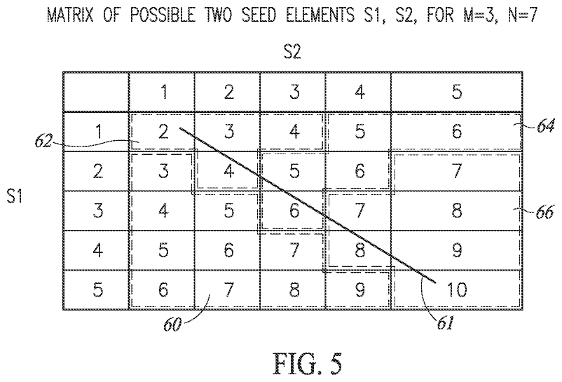

Reference is now made to FIG. 5, which illustrates a matrix of possible seed elements s1 (rows) and s2 (columns) and their sums for M=3 and N=7. Thus, the cell at {2,3} is 5, since 2+3=5. The cell at {3,2} is also 5, since addition is commutative, and thus, cell {3,2} is redundant. Moreover, the sum of seed elements greater than N is not possible, since a seed element defines a bit distance within the combination of length N and the total distance cannot be larger than the length N. From this, we can say that the sums of the M−1 elements of a seed is between N-M and N, with no duplicate elements. This may be written mathematically as:

For any M,N (N>M>1)

{s₁, . . . s_{M-1}} where (N−M)<Σ₁^{M-1}sᵢ<N (Equation 2)

The table in FIG. 5 has four sections. The cells in section 60, below a center diagonal 61, are redundant by symmetry and thus, should not be included when generating seeds. The cells in section 62 have sums Σ₁^{M-1} sᵢ equal to or less than N-M, where, in this example, N-M=4. The cells in section 64 have sums Σ₁^{M-1} sᵢ which are larger than N-M and smaller than N, where, in this example, N=7. The cells in section 66 have sums Σ₁^{M-1} sᵢ which are larger or equal to N.

According to equation 2, only those sums between N-M and N (i.e., those in section 64) are allowable. Thus, allowable seeds are: (1, 4), (1, 5), (2,3), (2,4) and (3,3).

In accordance with a preferred embodiment of the present invention, seed generators 20 and 50 may iterate over all groups of seed elements sᵢ and, using symmetry, may remove duplicates and those which are out of range (i.e., by selecting seeds whose seed elements sum to a value between N-M and N), with the results being the set of seeds to be utilized. The iteration may be any suitable method, such as by incrementing one of the seed elements at a time.

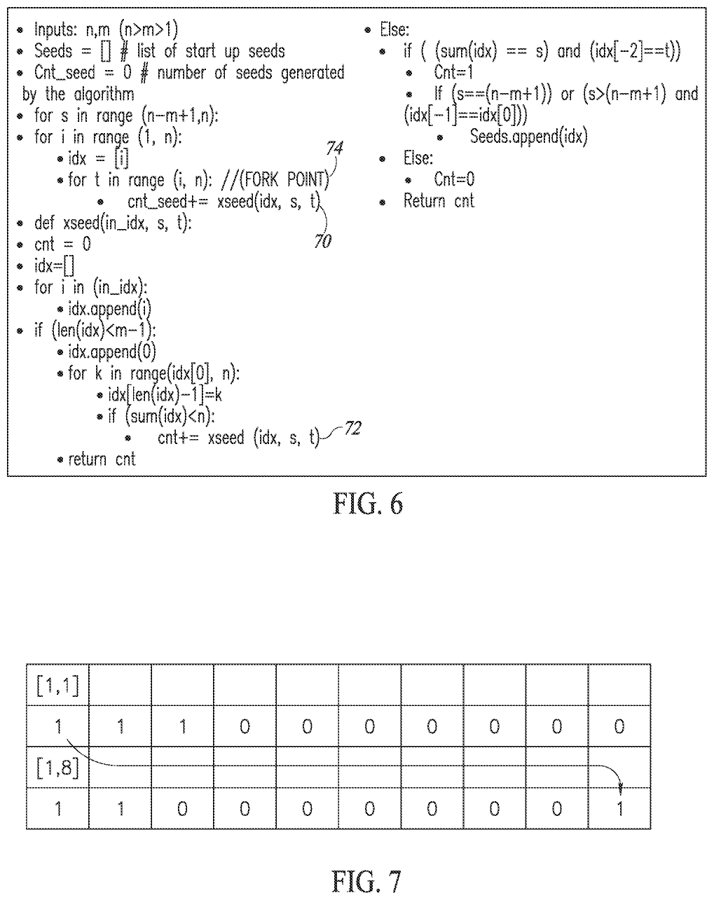

Applicant has also realized that the calculation may be done recursively and in parallel. Reference is now made to FIG. 6 which provides a calculation, to be performed by seed generators 20 or 50, to recursively produce seeds. FIG. 6 lists a function to generate a variable cnt_seed by calling a subroutine “xseed” (line 70). FIG. 6 also lists subroutine xseed which generates a variable cnt as a function of subroutine xseed (line 72). This is a recursive calculation.

In order to generate seeds in parallel, seed generators 20 or 50 may run subroutine xseed on (N−M+1) threads on a multi-threaded processor, where each thread has a different sum of seed elements. The threads may branch at a code line 74, which lists “for tin range (i, n)”. For example, for N=31 and M=6, there are 736,281 possible combinations and 23,751 seeds. The branching at code line 74 generates 31 threads, each to generate its own set of seeds. The number of seeds by thread are:
[0, 1505, 2340, 2660, 2620, 2375, 2076, 1800, 1550, 1324, 1121, 940, 780, 639, 516, 410, 320, 244, 181, 130, 90, 59, 36, 20, 10, 4, 1, 0, 0, 0, 0]

As can be seen, the threads are not perfectly balanced. Some generate many seeds, others generate less. However, splitting the work into independent threads enables relatively balanced scale-out computing, where each thread may activate moving Cspan generator 50 separately to generate a different initial combination CS[0] and to place it in a different column.

Applicant has realized that, not only do the combinations shift and rotate but that the seeds do so as well. This may be utilized to generate the seeds in parallel.

Reference is now briefly made to FIG. 7, which shows two seeds, [1,1] and [1,8], of a 10-bit sequence. The seed [1,1] of the 10-bit sequence generates the sequence 1110000000 while the seed [1,8] generates the sequence 1100000001, which is a shifted and rotated version of 1110000000 generated by seed [1,1]. Thus, seed [1,8] is redundant, as it will generate the same set of sequences as seed [1,1].

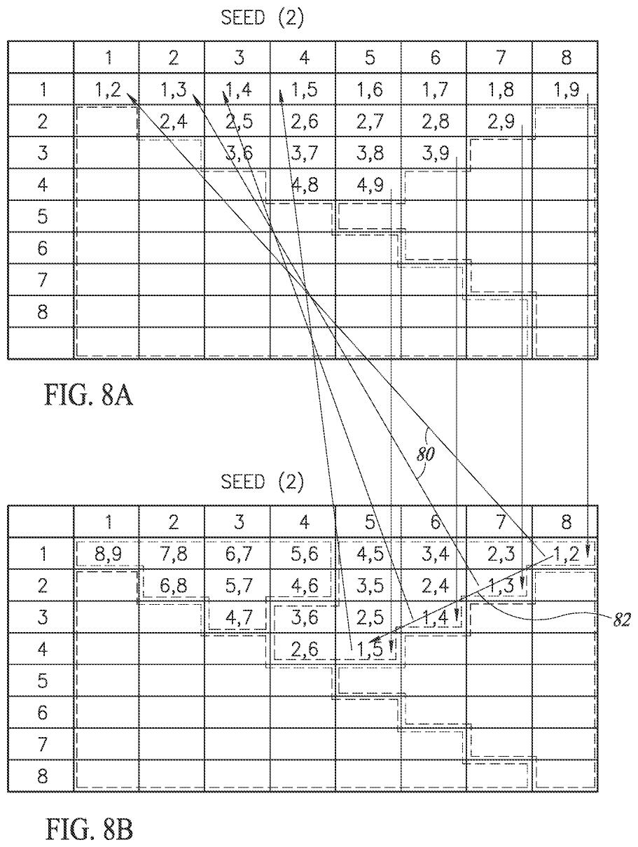

Reference is now made to FIGS. 8A and 8B, which show two tables of seed permutations for a 10-bit sequence, where each seed has two elements, listed on the rows and columns. In FIGS. 8A and 8B, seed elements 1,1 are shown as (1,2) to represent the set bit locations in the spanned combination (1110000000). FIG. 8A is the initial permutation or the “startup” seed while the corresponding table element in FIG. 8B is the final seed permutation. The arrows 80 indicate the repetitive (and therefore, unnecessary) seeds. Moreover, seeds on the diagonal line labeled 82 may be generated sequentially, starting from seed represented by bit locations (1,2) in the first row. Thus, seed having bit locations (1,2) generates the seed having bit locations (1,3) which generates the seed having bit locations (1,4), etc. Similarly, in the row to the left, the seed having bit locations (2,3) generates the seed having bit locations 2,4) which generates the seed having bit locations (2,5), etc. In general, a new seed may be generated from a previous seed by increasing the value of the last seed element.

Applicant has realized that each startup seed (i.e., the seed in the first row of the table of FIG. 8A) may generate K seeds by incrementing the value of the last coordinate (i.e. seed element) of the idx vector (of the code of FIG. 6) sequentially. With this, seeds may be generated in parallel, where each seed-generating-thread may “walk” across a different diagonal of FIG. 8A, starting from a different startup seed. Overall, each initial seed may generate (N−M)*N combinations each.

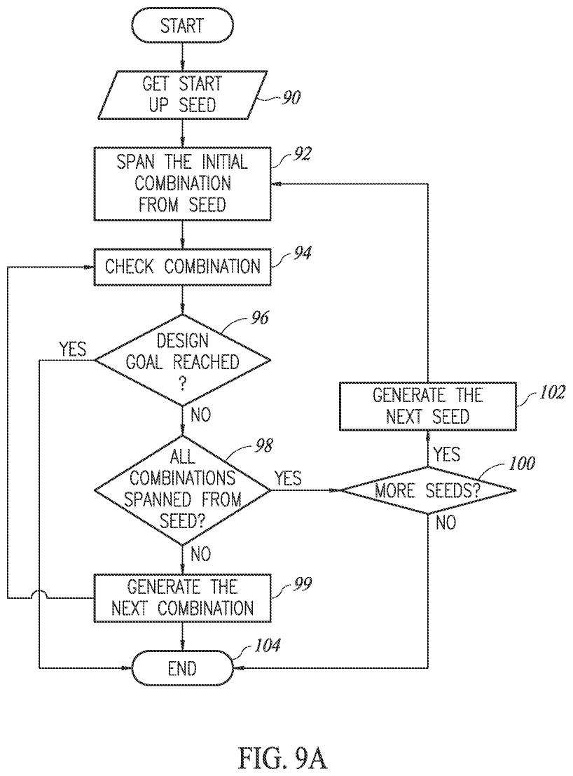

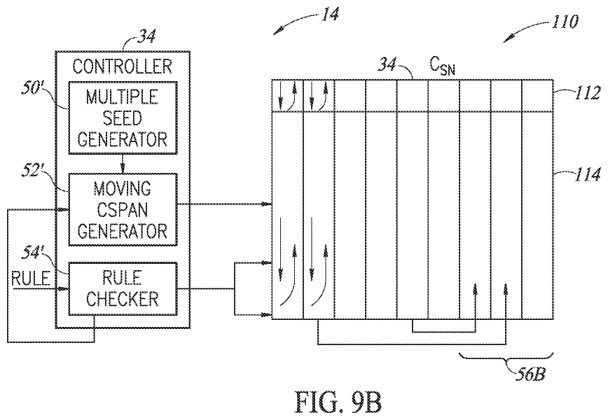

Applicant has realized that the same in-memory vector processor 14 may also be used to generate seeds, with one initial seed per column, making processor 14 operate as a combined seed and Cspan generator. Reference is now made to FIG. 9A, which illustrates the process of a single in-memory thread (stored in one column) which may perform as a seed generator, a Cspan generator and a rule checker, all in a single column of processor 14. Reference is also made to FIG. 9B, which illustrates a system 110 implementing the method of FIG. 9A. In this embodiment, multiple seed generator 50′, moving Cspan generator 52′ and rule checker 54′ are implemented in controller 34 of vector processor 14 rather than in CPU 12 and thus, control the operations within memory array 30. Moreover, in this embodiment, each column of memory array 30 may be divided into two sections, a seed portion 112 and a combination portion 114 and the single in-memory thread may implement the method of FIG. 9A as follows.

In step 90, seed generator 50′ of processor 14 may begin with an initial seed, using the function in FIG. 6, and may place it into seed portion 112 of a column. In step 92, Cspan generator 52′ of processor 14 may generate an initial combination CS[0] from the seed, in any of the ways described hereinabove, and may place it into combination portion 114 of the same column.

In step 94, rule checker 54′ of processor 14 may check the generated combination against the received rule. In step 96, rule checker 54′ may check if a design goal has been reached, defined by the received rule. If it has, rule checker 54′ may close the thread. If it hasn't, rule checker 54′ may check, in step 98, if all combinations have been spanned from the current seed. If not, Cspan generator 52′ may generate (step 99) the next combination in the combination portion of the column, to be checked in step 94, as described hereinabove.

If all combinations have been spanned from the current seed, processor 14 may check (step 100) if there are any more seeds to be generated and, if there are, may generate the next seed (step 102) in the seed portion of the column, thereby acting as a seed generator. The seed generation operation may use the algorithm provided in FIG. 6 and may be modified as described hereinabove with respect to FIGS. 8A and 8B.

It will be appreciated that the method of FIG. 9 may be performed in parallel on all columns. Thus, all columns may generate seeds at the same time, may check combinations at the same time and may generate combinations at the same time. In this embodiment, none of the columns may move to the end 104 until all of the columns are ready, nor will the check at step 98 (“all combinations spanned from seed?”) move to the check at step 100 (“more seeds?”) until all columns finish spanning combinations.

It will be appreciated that the massively parallel, in-memory operation of FIG. 9 may significantly decrease the time to generate combinations and to select combinations which satisfy the rule. This may enable combinations at large scale to be generated and checked efficiently.

It will be appreciated that the number of combinations increases exponentially. For example, for a projective plane of order 7, N=57 and M=8. For this embodiment, seed portion 112 may store M−1 (i.e., 7) 8-bit integers and thus, may store 56 bits, and combination portion 114 may store N=57 bits.

The number of possible combinations is 1,652,411,475 and the number of seeds is 28,989,675. The sum of the seed elements comes to 50, 51, 52, 53, 54, 55 or 56. The following table lists the number of initial seeds and number of combinations per sum of seeds.

TABLE 1

| Sum | # Initial seeds | # Combinations |
|---|---|---|
| 50 | 2,837,485 | 1,132,156,515 |
| 51 | 365,351 | 124,950,042 |
| 52 | 403,662 | 115,043,670 |
| 53 | 445,116 | 101,486,448 |
| 54 | 489,902 | 83,773,242 |
| 55 | 548,216 | 61,356,624 |
| 56 | 590,262 | 33,644,934 |

The example above may be implemented in 128K columns. It will take ˜300 repetitions for the ˜29M seeds.

Unless specifically stated otherwise, as apparent from the preceding discussions, it is appreciated that, throughout the specification, discussions utilizing terms such as “processing,” “computing,” “calculating,” “determining,” or the like, may refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

Embodiments of the present invention may include apparatus for performing the operations herein. This apparatus may be specially constructed for the desired purposes, or it may comprise a computing device or system typically having at least one processor and at least one memory, selectively activated or reconfigured by a computer program stored in the computer. The resultant apparatus when instructed by software may turn the general-purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general-purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for parallel combinatorial design, the system comprising:
a processor, an in-memory vector processor and a storage unit;
wherein said processor comprises:
a seed generator to generate at least one seed to generate combinations of length N, defining a space of N choices of which M choices are to be selected;
a Cspan generator to generate at least one combination from said at least one seed and to store each said at least one combination in a separate column of said in-memory vector processor; and
a rule checker to perform a parallel search at least in said in-memory vector processor for combinations which satisfy a rule,
said storage unit to receive search results of said rule checker from said in-memory vector processor.

2. The system according to claim 1 wherein said storage unit is implemented in one of said processor and said in-memory vector processor.

3. The system according to claim 1, said seed generator to generate a next seed if all possible seeds for N and M have not been generated and said Cspan generator to generate a plurality of combinations from said next seed and to store said combinations separately in columns of said in-memory vector processor.

4. The system according to claim 1, wherein said seed generator is a recursive, parallel seed generator to recursively generate a multiplicity of threads, each thread generating a plurality of seeds.

5. The system according to claim 4, said Cspan generator to generate at least an initial combination from each said at least one seed, to store each said initial combination in said separate column and to generate a next combination from a current combination for each combination currently stored in said separate column.

6. The system according to claim 5, said storage unit to provide said search results to said rule checker to check which said next combination satisfies said rule with respect to previous said search results.

7. A system for parallel combinatorial design, the system comprising:
in-memory vector processor comprising a memory array and a controller, said memory array having a seed portion and a combination portion, said controller comprising:
an in-memory seed generator to generate a plurality of further seeds from start-up seeds, each start-up seed being held in a separate column of said seed portion and said in-memory seed generator to operate on a plurality of said separate columns in parallel to generate said further seeds;
an in-memory C span generator to generate at least an initial combination from each said start-up seed and from each said further seed and to store each said initial combination in a separate column of said combination portion;
an in-memory rule checker to search in said combination portion for combinations which satisfy a rule; and
a storage area of said combination portion to receive search results of said in-memory rule checker,
said in-memory Cspan generator to generate a next combination from a current combination for each combination currently stored in said separate column of said combination portion;
said in-memory rule checker to check which said next combination satisfies said rule with respect to said search results stored in said storage area.

8. A method for generating seeds defining a set of combinations of length N having M set-bits from a set of seed elements, the method comprising:
iterating over groups of seed elements to generate potential seeds; and
selecting as candidate seeds those whose set of seed elements sum to a value between N−M and N.

9. The method according to claim 8 wherein said iterating comprises incrementing a value of one seed element of said set of seed elements.

10. The method according to claim 8 wherein said iterating and said selecting are performed recursively.

11. The method according to claim 10 and also comprising generating multiple seed generating threads, where each said thread has a different sum of said seed elements.

12. The method according to claim 11 and also comprising:
having a startup seed per each said thread; and
each said thread incrementing the value of a largest seed element of its startup seed sequentially.

13. A method for parallel combinatorial design, the method comprising:
generating at least one seed to generate combinations of length N, defining a space of N choices of which M choices are to be selected;
generating at least one combination from said at least one seed;
storing each said at least one combination in a separate column of an in-memory vector processor;
performing a parallel search at least in said in-memory vector processor for combinations which satisfy a rule; and
receiving results of said parallel search from said in-memory vector processor.

14. The method according to claim 13 wherein said receiving results comprising storing said results in said in-memory vector processor.

15. The method according to claim 13, said first generating comprising generating a next seed if all possible seeds for N and M have not been generated, and said second generating comprising generating a plurality of combinations from said next seed.

16. The method according to claim 13, wherein said first generating comprising recursively generating a multiplicity of threads, each thread generating a plurality of seeds.

17. The method according to claim 16, said second generating comprising generating at least an initial combination from each said at least one seed, storing each said initial combination in said separate column, and generating a next combination from a current combination for each combination currently stored in said separate column.

18. The method according to claim 17, and also comprising checking which said next combination satisfies said rule with respect to previous said results.

19. A method for parallel combinatorial design, the method comprising:
in-memory generating a plurality of further seeds from start-up seeds, each start-up seed being held in a separate column of a seed portion of a memory array, said generating operating in parallel on a plurality of said separate columns of said seed portion to generate said further seeds;
in-memory generating at least an initial combination from each said start-up seed and from each said further seed;
storing each said initial combination in a separate column of a combination portion of said memory array;
in-memory searching in said combination portion for combinations which satisfy a rule;
receiving results of said searching in said combination portion;
in-memory generating a next combination from a current combination for each combination currently stored in said separate column of said combination portion; and
in-memory checking which said next combination satisfies said rule with respect to said results.
